(19) United States
(12) Patent Application Publication
(10) Pub. No.: US 2026/0103021 A1
(43) Pub. Date: Apr. 16, 2026

(54) CARBON FIBER BICYCLE RIM WITH METAL WIRE AND MOLDING METHOD THEREOF

(71) Applicant: QUEST COMPOSITE TECHNOLOGY LIMITED, TAIKOO SHING (HK)

(72) Inventors: Lewis LIAO, TAIKOO SHING (HK); Robert WU, TAIKOO SHING (HK)

(21) Appl. No.: 18/953,418

(22) Filed: Nov. 20, 2024

(30) Foreign Application Priority Data
Sep. 12, 2024 (CN) 2024112840757

(51) Int. Cl. B60B 21/02

(52) U.S. Cl. CPC B60B 21/02; B60B 21/025; B60B 2310/204; B60B 2360/102; B60B 2360/3416; B60B 2900/212

(57) ABSTRACT

This invention relates to a carbon fiber bicycle rim and its molding method, belonging to the reinforcement technology of carbon fiber rims. Specifically, it includes a technique that integrates a metal wire (steel wire) into a sidewall of a carbon fiber rim body to enhance impact resistance and deformation resistance of the rim.

### BACKGROUND OF THE INVENTION

### 1. Field of the Invention

The present invention relates to carbon fiber bicycle rims and more particularly, to a carbon fiber bicycle rim that embeds a metal wire (steel wire) in a sidewall of a carbon fiber rim body to enhance impact resistance and deformation resistance of the rim.

### 2. Description of the Related Art

Although a traditional carbon fiber bicycle rim is lightweight and has an excellent strength characteristic, due to its single material properties, the traditional carbon fiber bicycle rim has limited resistance to high impact forces and is prone to deformation or damage under intense use. In the existing technology, the carbon fiber bicycle rim often lacks metal reinforcement, resulting in insufficient performance under strong impacts. As such, there is a need to enhance the overall performance of the rim.

### SUMMARY OF THE INVENTION

It is one objective of the present invention to provide a carbon fiber bicycle rim, which enhances impact resistance and deformation resistance to increase rim performance and durability.

To attain the above objective, the carbon fiber bicycle rim of the present invention comprises a rim body made of carbon fiber material and a metal wire embedded in a sidewall of the rim body. The cross-sectional shape of the metal wire can be square, triangular, circular, etc. The selection and configuration of the metal wire is determined according to the required strength and rigidity.

Secondly, the present invention provides a molding method of the carbon fiber bicycle rim, which comprises a step of integrating the metal wire into the sidewall of the carbon fiber rim body through an air-blowing process. This method ensures that a strong bond between the metal wire and the carbon fiber rim body to enhance the overall structural strength of the rim.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a cross-sectional view of a carbon fiber bicycle rim of a first embodiment of the present invention, showing that the cross-sectional shape of the metal wire is square.

FIG. 2 is a cross-sectional view of the carbon fiber bicycle rim of a second embodiment of the present invention, showing that the cross-sectional shape of the metal wire is triangular.

FIG. 3 is a cross-sectional view of the carbon fiber bicycle rim of a third embodiment of the present invention, showing that the cross-sectional shape of the metal wire is circular.

### DETAILED DESCRIPTION OF THE INVENTION

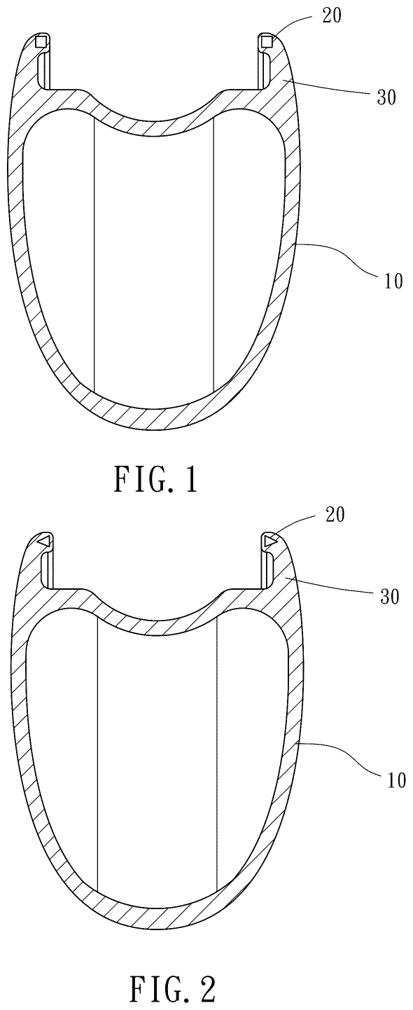

Referring to FIG. 1, a carbon fiber bicycle rim provided by a first embodiment of the present invention comprises a carbon fiber rim body 10 and two metal wires 20. The carbon fiber rim body 10 has two opposite sidewalls 30. The inner sides of the sidewalls 30 has a recess portion for accommodating a tire bead. The top portions of the sidewalls 30, particularly above the recess portion, are embedded by the metal wires 20 made of materials such as (but not limited to) steel. During the manufacturing of the carbon fiber bicycle rim, the carbon fiber material and the metal wires 20 are prepared. Depending on design requirements, various shapes of the metal wire 20 can be selected. In this embodiment, a square cross-section metal wire 20 is used. The carbon fiber material and the metal wires 20 are arranged in a rim-shaped mold, and the square cross-section metal wires 20 are embedded into the sidewalls 30 of the carbon fiber rim body 20 by using air-blowing integration technology, thereby completing the rim formation.

FIG. 2 shows a carbon fiber bicycle rim provided by a second embodiment of the present invention. This rim also comprises a caron fiber rim body 10 and two metal wires 20, but one of the differences between the first embodiment is that the cross-sectional shape of the metal wire 20 is triangular. As such, during the manufacturing of the carbon fiber bicycle rim of this embodiment, the carbon fiber material and the triangular cross-section metal wires 20 are arranged in a rim-shaped mold, and the triangular cross-section metal wires 20 are embedded into the sidewalls 30 of the carbon fiber rim body 20 by using air-blowing integration technology, thereby completing the rim formation.

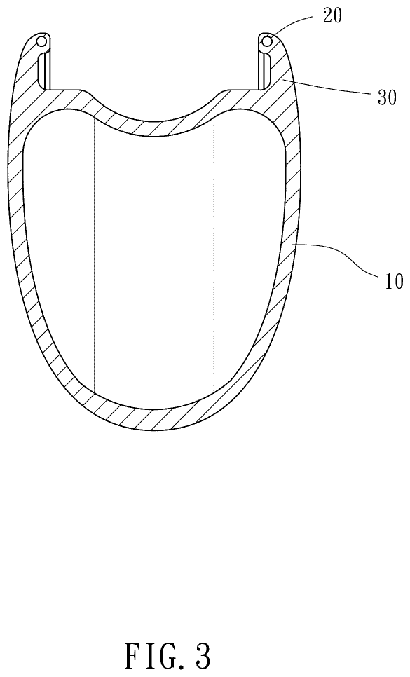

Further, please refer to FIG. 3, FIG. 3 shows a carbon fiber bicycle rim provided by a third embodiment of the present invention. This rim also comprises a caron fiber rim body 10 and two metal wires 20, but one of the differences between the aforesaid embodiment is that the cross-sectional shape of the metal wire 20 is circular. During the manufacturing of the carbon fiber bicycle rim of this embodiment, the carbon fiber material and the circular cross-section metal wires 20 are arranged in a rim-shaped mold, and the circular cross-section metal wires 20 are embedded into the sidewalls 30 of the carbon fiber rim body 20 by using air-blowing integration technology, thereby completing the rim formation.

Thereafter, the rims of the above-mentioned first to third embodiments are subjected to impact tests to verify their impact resistance, while also assessing their deformation resistance to ensure compliance with design requirements. The test results indicate that carbon fiber bicycle rims reinforced with the metal wires 20 exhibit superior impact resistance and deformation resistance compared to the traditional rims.

As indicated above, the present invention significantly improves impact resistance and deformation resistance of the carbon fiber bicycle rim by embedding the metal wires 20 in the carbon fiber rim body 10. This design not only improves the performance of the rim, but also innovates the design of traditional carbon fiber rim, which has significant practical value and market potential.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A carbon fiber bicycle rim comprising:
a carbon fiber rim body having a sidewall; and
a metal wire embedded in the sidewall of the carbon fiber rim body to enhance impact resistance and deformation resistance of the carbon fiber rim body, thereby increasing performance and durability of the carbon fiber bicycle rim.

2. The carbon fiber bicycle rim as claimed in claim 1, wherein the metal wire is a steel wire.

3. The carbon fiber bicycle rim as claimed in claim 1, wherein a cross-sectional shape of the metal wire is square, triangular or circular.

4. A method of molding the carbon fiber bicycle rim as claimed in claim 1, comprising a step of integrating the metal wire into the sidewall of the carbon fiber rim body through an air-blowing process to ensure a strong bond between the metal wire and the carbon fiber rim body, thereby enhancing an overall structural strength of the carbon fiber bicycle rim.
